(19) United States
(12) Patent Application Publication
(10) Pub. No.: US 2023/0183522 A1
(43) Pub. Date: Jun. 15, 2023

(54) POLYURETHANE COMPOSITION WITH IMPROVED ADHESION ON PAINTED SURFACES

(71) Applicant: SIKA TECHNOLOGY AG, Baar (CH)

(72) Inventors: Michele GATTI, Frick (CH); Martin ZÄCH, Zürich (CH)

(73) Assignee: SIKA TECHNOLOGY AG, Baar (CH)

(21) Appl. No.: 17/924,078

(22) PCT Filed: Jun. 4, 2021
(86) PCT No.: PCT/EP2021/065033

§ 371 Date: Nov. 8, 2022

(30) Foreign Application Priority Data
Jun. 12, 2020 (EP) 20179659.6

(51) Int. Cl. C09D 175/08; C08G 18/10; C08K 3/04; C08G 18/48; C08G 18/30

(52) U.S. Cl. CPC C09D 175/08; C08G 18/10; C08K 3/04; C08G 18/4825; C08G 18/307; C08G 2190/00

(57) ABSTRACT

A moisture-curing, one-component polyurethane composition, containing at least one isocyanate group-containing polyether urethane polymer obtained by reacting at least one polyisocyanate with at least one polyether polyol; at least one isocyanurate-containing trimer of 1-isocyanato-3,3,5-trimethyl-5-isocyanatomethyl cyclohexane or 1,6-hexane diisocyanate in a quantity of between 1 and 4 percent by weight in the composition; at least one polyether with blocked hydroxyl groups, which is free of isocyanate groups, as a plasticiser, in a quantity of more than 5 percent by weight in the composition. Where moisture is excluded, the moisture-curing polyurethane composition has good storage stability, good processability and good thermal stability, and surprisingly good adhesive effect on highly scratch-resistant, hydrophobic automotive paints, and no pretreatment with adhesion promoters, primers or activators is needed. It is especially suitable for use as an elastic adhesive in the production of means of transport.

### TECHNICAL FIELD

The invention relates to moisture-curing one-component polyurethane compositions and to the use thereof as elastic adhesives, sealants and coatings, especially on automotive paint as substrate.

### STATE OF THE ART

Polyurethane compositions which crosslink through reaction of isocyanate groups with moisture or water and cure to give elastomers are especially used as elastic adhesives, sealants or coatings in the construction and manufacturing industry, for example for bonding of components in assembly, for filling joints, as floor coating or as roof seal. In addition, they find wide use as versatile construction adhesives, for example for the installation of windowpanes in modes of transport such as trains or automobiles. Owing to their good adhesion and elasticity, they can gently damp and buffer forces acting on the substrates, triggered for instance by vibrations or variations in temperature.

Polyurethane compositions may be formulated as one-component or two-component compositions. One-component polyurethane compositions have the advantage that they do not have to be mixed before or during application and are therefore more popular for many applications, and users of these methods value the easier and more error-resistant application of one-component polyurethane adhesives.

According to the substrate to which they are applied, however, polyurethane compositions sometimes meet their limits with regard to adhesion performance. Adhesion on modern automotive paints or similar paints, for example, is a challenge since such paints are usually highly hydrophobic and have a smooth hard surface. Successful bonding, for example of windshields, with a one-component polyurethane composition on automotive paint depends significantly on the quality of the paint substrate, on the substrate preparation process, and on the selected conditions for the bonding. The substrate, according to the paint, can be bonded more or less satisfactorily in an extremely simple manner (can be bonded to almost any adhesive) to an extremely demanding manner (aged material, extended baking conditions at high temperature, high level of crosslinking). Some particularly difficult paints that are particularly scratch- and soiling-resistant, for example, can barely still be bonded, or can not be bonded at all, with customary polyurethane adhesives. Additives that improve adhesion to paint are known in the literature. However, the effect thereof is frequently limited, and the integration thereof in a sufficient amount into the adhesive matrix can lead to restrictions in the mechanical properties (for example low elongation at break).

Disclosures US2016002511 A1 and U.S. Pat. No. 9,534,073 B2 teach, for example, the importance of HDI isocyanurates and biurets as adhesion promoter on coated steel, and identify the ratio between aliphatic and aromatic isocyanates and the catalyst loading as key parameters for obtaining good adhesion. However, even such systems cannot always fully cope with the most difficult modern automotive paints.

Consequently, paint surfaces that are difficult to bond typically require complex pre-treatment, for example in the form of mechanical pretreatment such as grinding or roughening, or a physicochemical pretreatment in the form of a primer, activator or adhesion promoter. However, this is not always possible, for example, on production lines for modes of transport or automobiles since the solvents that are usually present in pretreatment compositions are problematic on the production line. In all cases, such pretreatments are time-consuming and costly and therefore undesirable.

There is therefore the need for a one-component polyurethane composition that can bond even the most difficult automotive paints without difficulty, and for that purpose does not require any particular mechanical or physicochemical pretreatment of the paint surface prior to bonding.

### SUMMARY OF THE INVENTION

It is therefore an object of the present invention to provide moisture-curing one-component polyurethane compositions that overcome the disadvantages of the prior art.

The object is achieved by the moisture-curing one-component polyurethane composition as claimed in claim 1. It contains at least one polyether urethane polymer containing isocyanate groups, at least one isocyanurate-containing trimer of 1-isocyanato-3,3,5-trimethyl-5-isocyanatomethylcyclohexane or hexane 1,6-diisocyanate in an amount present in the composition of between 1% and 4% by weight, and at least one polyether having blocked hydroxyl groups which is free of isocyanate groups as plasticizer, in an amount present in the composition of more than 5% by weight.

In preferred embodiments, the composition of the invention has a monomeric diisocyanate content of less than 0.1%; it can thus be safely handled even without special safety precautions and can be sold without hazard labeling in many countries. Surprisingly, the composition of the invention, in all embodiments, has excellent adhesion on hydrophobic automotive paints having high scratch resistance even without prior pretreatment of the paint surfaces, high heat stability of the bond, and high tensile strength and elasticity after curing, which is very advantageous for many applications. These advantageous properties cannot be expected from the prior art.

The moisture-curing polyurethane composition of the invention has excellent storage stability with exclusion of moisture and good processibility, and has a long open time coupled with rapid curing. This gives rise to an elastic material of high tensile strength coupled with high extensibility, excellent bonding properties even on the most difficult paint substrates, and high stability to heat.

The moisture-curing polyurethane composition is particularly suitable for use as an elastic adhesive, elastic sealant or elastic coating, especially elastic adhesive on a production line for modes of transport.

Further aspects of the invention are the subject of further independent claims. Particularly preferred embodiments of the invention are the subject of the dependent claims.

Ways of Executing the Invention

The invention provides a moisture-curing one-component polyurethane composition comprising
at least one polyether urethane polymer containing isocyanate groups that has been obtained from the reaction of at least one polyisocyanate with at least one polyether polyol;
at least one isocyanurate-containing trimer I of 1-isocyanato-3,3,5-trimethyl-5-isocyanatomethylcyclohexane or hexane 1,6-diisocyanate in an amount present in the composition of between 1% and 4% by weight;
at least one polyether having blocked hydroxyl groups which is free of isocyanate groups as plasticizer, in an amount present in the composition of more than 5% by weight.

“Monomeric diisocyanate” refers to an organic compound having two isocyanate groups separated by a divalent hydrocarbyl radical having 4 to 15 carbon atoms.

A “polyether urethane polymer” refers to a polymer having ether groups as repeat units and additionally containing urethane groups.

Substance names beginning with “poly”, such as polyol, refer to substances containing, in a formal sense, two or more of the functional groups that occur in their name per molecule.

A “blocked hydroxyl group” refers to a hydroxyl group converted by chemical reaction to a group unreactive toward isocyanate groups.

A “plasticizer” refers to a substance which is liquid at room temperature and remains unchanged in the composition after curing thereof and plasticizes the cured composition.

“NCO content” refers to the content of isocyanate groups in % by weight. “Molecular weight” refers to the molar mass (in grams per mole) of a molecule or a molecule residue. “Average molecular weight” refers to the number-average molecular weight (Mₙ) of a polydisperse mixture of oligomeric or polymeric molecules or molecule residues. It is determined by means of gel permeation chromatography (GPC) against polystyrene as standard, especially with tetrahydrofuran as mobile phase, refractive index detector and evaluation from 200 g/mol.

A substance or composition is referred to as “storage-stable” or “storable” when it can be stored at room temperature in a suitable container over a prolonged period, typically over at least 3 months to up to 6 months or more, without any change in its application or use properties to a degree of relevance for the use thereof as a result of the storage.

“Room temperature” refers to a temperature of 23° C.

All industry standards and norms mentioned in this document relate to the versions valid at the date of first filing.

Percentages by weight (% by weight), abbreviated to wt %, refer to proportions by mass of a constituent of a composition or a molecule, based on the overall composition or the overall molecule, unless stated otherwise. The terms “mass” and “weight” are used synonymously in the present document.

The polyether urethane polymer containing isocyanate groups as claimed in claim 1 may also be referred to as polyurethane prepolymer.

Preferably, the polyether urethane polymer containing isocyanate groups has an average molecular weight Mₙ in the range from 1500 to 20 000 g/mol, preferably 2500 to 15 000 g/mol, especially 3500 to 10 000 g/mol.

The polyether urethane polymer containing isocyanate groups preferably has an NCO content in the range from 0.5% to 6% by weight, particularly preferably 0.6% to 4% by weight, more preferably 1% to 3% by weight, especially 1.2% to 2.5% by weight.

Repeat units present in the polyether urethane polymer containing isocyanate groups are preferably 1,2-ethyleneoxy, 1,2-propyleneoxy, 1,3-propyleneoxy, 1,2-butyleneoxy or 1,4-butyleneoxy groups. Preference is given to 1,2-ethyleneoxy and 1,2-propyleneoxy groups.

More preferably, repeat units present therein are mainly or exclusively 1,2-propyleneoxy groups.

A particularly preferred polyether urethane polymer containing isocyanate groups has 80% to 100% by weight of 1,2-propyleneoxy groups in the polyether segment and 0% to 20% by weight of 1,2-ethyleneoxy groups.

If 1,2-ethyleneoxy groups are also present, the 1,2-propyleneoxy groups and the 1,2-ethyleneoxy groups each especially form homogeneous blocks, and the poly(1,2-ethyleneoxy) blocks are at the chain ends. Such a polymer enables moisture-curing polyurethane compositions having particularly rapid curing and particularly good heat stability.

The preferred polyether urethane polymers containing isocyanate groups enable high-quality, efficiently processible moisture-curing polyurethane compositions having high strength, extensibility and elasticity.

Suitable monomeric diisocyanates are commercial aromatic or aliphatic diisocyanates such as, in particular, diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), naphthalene 1,5-diisocyanate (NDI), hexane 1,6-diisocyanate (HDI), 2,2(4),4-trimethylhexamethylene 1,6-diisocyanate (TMDI), cyclohexane 1,3—or 1,4-diisocyanate, 1-isocyanato-3,3,5-trimethyl-5-isocyanatomethylcyclohexane (isophorone diisocyanate or IPDI), perhydro-diphenylmethane 2,4′- or 4,4′-diisocyanate (HMDI), 1,3—or 1,4-bis(isocyanatomethyl)cyclohexane, m- or p-xylylene diisocyanate (XDI), or mixtures thereof.

The monomeric diisocyanate used for the reaction is preferably diphenylmethane 4,4′-diisocyanate (4,4′-MDI), tolylene 2,4-diisocyanate or mixtures thereof with tolylene 2,6-diisocyanate (TDI), 1-isocyanato-3,3,5-trimethyl-5-isocyanatomethylcyclohexane (IPDI) or hexane 1,6-diisocyanate (HDI). Preference is also given to a combination of two or more of these monomeric diisocyanates.

Particular preference is given to 4,4′-MDI. This 4,4′-MDI is of a quality that contains only small fractions of diphenylmethane 2,4′- and/or 2,2′-diisocyanate and is solid at room temperature. It enables moisture-curing polyurethane compositions having particularly rapid curing and particularly high strength coupled with high extensibility and elasticity.

The 4,4′-MDI has preferably been distilled and has a purity of at least 95%, especially at least 97.5%.

A commercially available diphenylmethane 4,4′-diisocyanate of this quality is, for example, Desmodur® 44 MC (from Covestro) or Lupranat® MRSS or ME (from BASF) or Suprasec® 1400 (from Huntsman).

Also particularly preferred is 1-isocyanato-3,3,5-trimethyl-5-isocyanatomethylcyclohexane (IPDI). IPDI-based moisture-curing polyurethane compositions have high strength coupled with high extensibility and elasticity, and enable products having particularly high weathering stability.

The polyether polyol preferably has an average molecular weight Mₙ in the range from 1′000 to 15′000 g/mol, more preferably 1′500 to 12′000 g/mol, especially 2′000 to 8′000 g/mol.

The polyether preferably has an OH number in the range from 8 to 112 mg KOH/g, more preferably in the range from 10 to 75 mg KOH/g, especially in the range from 12 to 56 mg KOH/g.

The polyether polyol preferably has an average OH functionality in the range from 1.7 to 3.

Suitable polyether polyols are polyoxyalkylene diols and/or polyoxyalkylene triols, especially polymerization products of ethylene oxide or 1,2-propylene oxide or 1,2—or 2,3-butylene oxide or oxetane or tetrahydrofuran or mixtures thereof, where these may be polymerized with the aid of a starter molecule having two or three active hydrogen atoms, especially a starter molecule such as water, ammonia or a compound having multiple OH or NH groups, such as, for example, ethane-1,2-diol, propane-1,2—or −1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3—or −1,4-dimethanol, bisphenol A, hydrogenated bisphenol A, 1,1,1-trimethylolethane, 1,1,1-trimethylolpropane, glycerol or aniline, or mixtures of the abovementioned compounds.

Particular preference is given to polyoxypropylene diols, polyoxypropylene triols, or ethylene oxide-terminated polyoxypropylene diols or triols. These are polyoxyethylene/polyoxypropylene copolyols which are obtained especially by further alkoxylating polyoxypropylene diols or triols with ethylene oxide on conclusion of the polypropoxylation reaction, with the result that they ultimately have primary hydroxyl groups.

Preferred polyether polyols have a degree of unsaturation of less than 0.02 meq/g, especially less than 0.01 meq/g.

In one embodiment, preference is given to a trimethylolpropane—or especially glycerol-started, optionally ethylene oxide-terminated polyoxypropylene triol having an OH number in the range from 20 to 42 mg KOH/g, especially 22 to 35 mg KOH/g, and an average OH functionality in the range from 2.2 to 3.0, preferably 2.2 to 2.8, especially 2.2 to 2.6.

In a further embodiment, preference is given to a polyoxypropylene diol having an OH number in the range from 8 to 112 mg KOH/g, preferably in the range from 10 to 75 mg KOH/g, especially in the range from 12 to 56 mg KOH/g.

The reaction is preferably conducted with exclusion of moisture at a temperature in the range from 20 to 160° C., especially 40 to 140° C., optionally in the presence of suitable catalysts.

In preferred embodiments, the polyether urethane polymer containing isocyanate groups has a monomeric diisocyanate content of not more than 0.5% by weight, preferably not more than 0.3% by weight, especially not more than 0.2% by weight. These embodiments have surprisingly good adhesion properties and are applicable in a particularly simple manner and have particularly good mechanical properties.

In these embodiments, the NCO/OH ratio in the reaction between the monomeric diisocyanate with the polyether polyol is especially in the range from 3/1 to 10/1, more preferably in the range from 3/1 to 8/1, especially in the range from 4/1 to 7/1.

After the reaction, the monomeric diisocyanate remaining in the reaction mixture in these embodiments is removed by means of a suitable separation method down to the residual content described.

A preferred separation method is a distillative method, especially thin-film distillation or short-path distillation, preferably with application of reduced pressure.

Particular preference is given to a multistage method in which the monomeric diisocyanate is removed in a short-path evaporator with a jacket temperature in the range from 120 to 200° C. and a pressure of 0.001 to 0.5 mbar. In the case of 4,4′-MDI, which is preferred as monomeric diisocyanate, distillative removal is particularly demanding. It has to be ensured, for example, that the condensate does not solidify and block the system. Preference is given to working with a jacket temperature in the range from 160 to 200° C. at 0.001 to 0.5 mbar, and condensing the monomer removed at a temperature in the range from 40 to 60° C.

In the case of IPDI, which is preferred as monomeric diisocyanate, the jacket temperature is preferably in the range from 140 to 180° C.

Preference is given to reacting the monomeric diisocyanate with the polyether polyol and optionally subsequently removing the majority of the monomeric diisocyanate remaining in the reaction mixture without the use of solvents or entraining agents.

Preference is given to subsequently reusing any monomeric diisocyanate removed after the reaction, i.e. using it again for the preparation of polyurethane polymer containing isocyanate groups.

In the reaction, the OH groups of the polyether polyol react with the isocyanate groups of the monomeric diisocyanate. This results also in what are called chain extension reactions, in that there is reaction of OH groups and/or isocyanate groups of products of the reaction between polyol and monomeric diisocyanate. The higher the NCO/OH ratio chosen, the lower the level of chain extension reactions that takes place, and the lower the polydispersity and hence the viscosity of the polymer obtained. A measure of the chain extension reaction is the average molecular weight of the polymer, or the breadth and distribution of the peaks in the GPC analysis. A further measure is the effective NCO content of the polymer freed of monomers relative to the theoretical NCO content calculated from the reaction of every OH group with a monomeric diisocyanate.

The NCO content in the polyether urethane polymer is preferably at least 80%, especially at least 85%, of the theoretical NCO content which is calculated from the addition of one mole of monomeric diisocyanate per mole of OH groups of the polyether polyol. Such a polyether urethane polymer has particularly low viscosity and enables moisture-curing polyurethane compositions having particularly good application properties.

A particularly preferred polyether urethane polymer has an NCO content in the range from 1% to 2.5% by weight, especially 1.1° A to 2.1% by weight, and a monomeric diisocyanate content of not more than 0.3% by weight, especially not more than 0.2% by weight, and is obtained from the reaction of 4,4′-MDI or

IPDI with an optionally ethylene oxide-terminated polyoxypropylene triol having an average OH functionality in the range from 2.2 to 3, preferably 2.2 to 2.8, especially 2.2 to 2.6, and an OH number in the range from 20 to 42 mg KOH/g, especially in the range from 22 to 35 mg KOH/g. Such a polymer enables a particularly attractive combination of low viscosity, long open time coupled with rapid curing and high extensibility and elasticity and high strength.

A further particularly preferred polyether urethane polymer has an NCO content in the range from 0.8% to 2.4% by weight, especially 1.2% to 2.1% by weight, and a monomeric diisocyanate content of not more than 0.3% by weight, especially not more than 0.2% by weight, and is obtained from the reaction of 4,4′-MDI with a polyoxypropylene diol having an OH number in the range from 13 to 38 mg KOH/g, especially 22 to 32 mg KOH/g. Such a polymer is of particularly low viscosity and is especially suitable for combination with a compound containing isocyanate groups and having an NCO functionality of at least 2.2, especially an oligomeric isocyanate or a corresponding polymer containing isocyanate groups. It enables particularly high extensibility and elasticity.

The moisture-curing polyurethane composition preferably contains 25% to 60% by weight, more preferably 30% to 55% by weight, especially 35% to 50% by weight, of polyether urethane polymer containing isocyanate groups, especially having a monomeric diisocyanate content of not more than 0.5% by weight, preferably not more than 0.4% by weight, especially not more than 0.2% by weight.

The moisture-curing polyurethane composition also contains at least one isocyanurate-containing trimer I of 1-isocyanato-3,3,5-trimethyl-5-isocyanatomethylcyclohexane (IPDI) or hexane 1,6-diisocyanate (HDI) in an amount present in the composition of between 1% and 4% by weight. Other oligomeric isocyanates have been found to be far less suitable.

Suitable oligomeric isocyanates are especially HDI isocyanurates such as Desmodur® N 3300, N 3600 or N 3790 BA (all from Covestro), Tolonate® HDT, HDT-LV or HDT-LV2 (from Vencorex), Duranate® TPA-100 or THA-100 (from Asahi Kasei) or Coronate® HX (from Nippon Polyurethane), and IPDI isocyanurates, for example in solution as Desmodur® Z 4470 (from Covestro) or in solid form as Vestanat® T1890/100 (from Evonik).

Preference is given to HDI isocyanurate-containing trimers.

The amount of isocyanurate-containing trimer I is between 1% and 4% by weight, based on the composition. Below 1% by weight, adhesion to automotive paints is inadequate, and above 4% by weight, inadequate mechanical properties of the composition are obtained, more particularly with rapidly declining elastic properties. Preferably, the content of isocyanurate-containing trimer I is between 1.25% and 3.5% by weight, more preferably between 1.5% and 3% by weight. In this range, bonding properties to automotive paints are particularly good, and mechanical properties such as tensile strength and extensibility of the cured composition are ideal for an elastic adhesive.

The moisture-curing polyurethane composition also contains at least one polyether having blocked hydroxyl groups which is free of isocyanate groups as plasticizer, in an amount present in the composition of more than 5% by weight.

The hydroxyl groups of the polyether are especially blocked in such a way that it does not enter into any chemical reactions before and during the curing of the polyurethane composition, i.e. remains unchanged in the cured composition. If the moisture-curing polyurethane composition comprises blocked amines such as oxazolidines or aldimines in particular, the polyether having blocked hydroxyl groups is preferably free of aceto ester groups.

The polyether having blocked hydroxyl groups is preferably liquid at room temperature.

The polyether having blocked hydroxyl groups preferably has a viscosity at 20° C. in the range from 30 to 5′000 mPa·s, more preferably 40 to 2′000 mPa·s, especially preferably 50 to 1′000 mPa·s, in particular 50 to 500 mPa·s. The viscosity is determined here with a cone-plate viscometer having a cone diameter 25 mm, cone angle 1°, cone tip-plate distance 0.05 mm, at a shear rate of 10 s⁻¹.

The blocked hydroxyl groups are preferably selected from ester, aceto ester, carbonate, acetal and urethane groups. Preference is given to ester, aceto ester, carbonate or urethane groups. Hydroxyl groups are particularly easily convertible to these groups, and they are particularly stable and compatible with polyether urethane polymers.

Particular preference is given to ester, carbonate or urethane groups, especially ester or urethane groups. These groups are also stable in compositions containing blocked amines releasable by means of hydrolysis, such as oxazolidines or aldimines, and do not react with the amines released therefrom in the course of curing of the composition.

Most preferred are ester groups, especially acetate groups. These enable particularly low viscosity and are easily obtainable.

Particular preference is given to an ester group, especially an ester group having 1 to 8 carbon atoms, especially an acetate group or benzoate group. These are preparable in a particularly simple manner.

Most preferred is an acetate group. A polyether having blocked hydroxyl groups in the form of acetate groups is of particularly low viscosity, is preparable in a very particularly simple manner and is particularly inexpensive.

Also preferred is a urethane group, especially a phenylurethane group or a p-toluenesulfonylurethane group. A polyether having such blocked hydroxyl groups has a manageable viscosity and is preparable in a particularly simple manner.

A preferred aceto ester group is an acetoacetate group, but only if the composition is free of blocked amines releasable by means of hydrolysis. A preferred carbonate group is a methyl carbonate group. A preferred acetate group is a 1,4-dimethyl-2-oxa-pentoxy group, a 2-oxacyclopentyloxy group or a 2-oxacyclohexyloxy group, especially a 1,4-dimethyl-2-oxa-pentoxy group.

Repeat units present in the polyether having blocked hydroxyl groups are preferably 1,2-ethyleneoxy, 1,2-propyleneoxy, 1,3-propyleneoxy, 1,2-butyleneoxy or 1,4-butyleneoxy groups, especially 1,2-propyleneoxy groups. Preferably at least 70%, especially at least 80%, of the repeat units consist of 1,2-propyleneoxy groups, and optionally at most 30%, especially at most 20%, of the repeat units consist of 1,2-ethyleneoxy groups.

More preferably, the repeat units consist entirely of 1,2-propyleneoxy groups. This enables polyurethane compositions having particularly good hydrolysis stability.

More preferably, the polyether having block hydroxyl groups is derived from a hydroxy-functional polyether having an average OH functionality in the range from 1 to 3, especially 1 to 2.

Suitable hydroxy-functional polyethers having an OH functionality of 1 are especially what are called polyoxypropylene monools.

Preferred starters for polyoxypropylene monools are methanol, ethanol, propanol, isopropanol, butanol, isobutanol, tert-butanol, pentanol, hexanol, 2-ethylhexanol, lauryl alcohol, myristyl alcohol, palmityl alcohol, allyl alcohol, cyclohexanol, benzyl alcohol or phenol, especially methanol, ethanol or butanol, most preferably butanol.

Suitable hydroxy-functional polyethers having an OH functionality of 1 are especially what are called polyoxypropylene polyols.

Preferred starters for polyoxypropylene polyols are ethane-1,2 diol, propane-1,2-diol, propane-1,3-diol, butane-1,4-diol, trimethylolpropane, glycerol, pentaerythritol, butane-1,2,3,4-tetraol (threitol or erythritol), pentane-1,2,3,4,5-pentol (xylitol) or hexane-1,2,3,4,5,6-hexol (mannitol or sorbitol), more preferably ethane-1,2 diol, propane-1,2-diol, propane-1,3-diol, butane-1,4-diol, trimethylolpropane or glycerol, especially propane-1,2-diol or glycerol, most preferably propane-1,2-diol.

A polyether having blocked hydroxyl groups preferably has an average molecular weight Mₙ in the range from 600 to 15′000 g/mol, particularly preferably 700 to 10′000 g/mol, more preferably 900 to 5′000 g/mol, especially 900 to 2′500 g/mol, determined by means of gel permeation chromatography (GPC) against polystyrene as standard with tetrahydrofuran as mobile phase, refractive index detector and evaluation from 200 g/mol.

This afford moisture-curing polyurethane compositions having particularly high extensibility and elasticity. Such compositions especially have a long processing time (open time) coupled with rapid curing and high cold flexibility.

In a preferred embodiment, the polyether having blocked hydroxyl groups is derived from a butanol-started polyoxypropylene monool having an OH number in the range from 25 to 90 mg KOH/g, preferably in the range from 50 to 80 mg KOH/g. This afford moisture-curing polyurethane compositions having particularly good processibility and particularly high cold flexibility. The blocked hydroxyl group here is preferably an acetate group.

In a further preferred embodiment, the polyether having blocked hydroxyl groups is derived from a polyoxypropylene diol having an OH number in the range from 12 to 125 mg KOH/g, preferably in the range from 22 to 125 mg KOH/g, especially in the range from 45 to 125 mg KOH/g. This afford moisture-curing polyurethane compositions having very good processibility and good cold flexibility. The blocked hydroxyl groups here are preferably acetate groups.

In a further preferred embodiment, the polyether having blocked hydroxyl groups is derived from a trimethylolpropane—or especially glycerol-started, optionally ethylene oxide-terminated polyoxypropylene triol having an average OH functionality in the range from 2.2 to 3 and an OH number in the range from 22 to 56 mg KOH/g.

The polyether having blocked hydroxyl groups is especially obtained by reacting at least one hydroxy-functional polyether with at least one suitable blocking agent for hydroxyl groups.

For the reaction, the blocking agent is used at least stoichiometrically in relation to the hydroxyl groups. For the blocking, methods customary for the respective reactive groups are used, optionally with additional use of catalysts or solvents. If the blocking reaction forms elimination products, these are removed from the reaction mixture by a suitable method, especially by means of distillation.

Suitable blocking agents are nucleophilic compounds that enter into an addition or substitution reaction with hydroxyl groups.

Especially suitable are carboxylic acids, carbonyl chlorides, carboxylic esters or carboxylic anhydrides, diketene, 2,2,5-trimethyl-4H-1,3-dioxin-2-one, tert-butyl acetoacetate, dialkyl carbonates, monoisocyanates, (meth)acrylam ides, methylenemalonates or cyanoacrylates.

Preference is given to carboxylic acids, carbonyl chlorides, carboxylic esters or carboxylic anhydrides, with formation of blocked hydroxyl groups in the form of ester groups. Among these, preference is given to carboxylic anhydrides or carboxylic esters, especially acetic anhydride.

In the case of acetic anhydride as blocking agent, acetic acid is distilled off in the course of the reaction, with formation of blocked hydroxyl groups in the form of acetate groups.

In the case of isopropenyl acetate as blocking agent, acetone is distilled off in the course of the reaction, likewise with formation of blocked hydroxyl groups in the form of acetate groups.

Preference is further given to diketene, 2,2,5-trimethyl-4H-1,3-dioxin-4-one or sterically hindered small aceto esters such as, in particular, tert-butyl acetate, with formation of blocked hydroxyl groups in the form of aceto ester groups.

Preference is further given to dialkyl carbonates, with formation of blocked hydroxyl groups in the form of carbonate groups.

Preference is further given to monoisocyanates, with formation of blocked hydroxyl groups in the form of urethane groups. Preference is given to phenyl isocyanate or p-toluenesulfonyl isocyanate.

Suitable hydroxy-functional polyethers are especially those having an OH functionality in the range from 1 to 3 and an average molecular weight Mₙ in the range from 600 to 15′000 g/mol, particularly preferably 700 to 10′000 g/mol, more preferably 900 to 5′000 g/mol, especially 900 to 2′500 g/mol.

Preference is given to polyoxypropylene monools having an OH number in the range from 25 to 90 mg KOH/g, preferably in the range from 50 to 80 mg KOH/g, especially alcohol-started polyoxypropylene monools, especially started from methanol, ethanol, propanol, isopropanol, butanol, isobutanol, tert-butanol, pentanol, hexanol, 2-ethylhexanol, lauryl alcohol, myristyl alcohol, palmityl alcohol, allyl alcohol, cyclohexanol, benzyl alcohol or phenol. Among these, preference is given to alkyl alcohol-started polyoxypropylene monools, especially started from methanol, ethanol or butanol. Particular preference is given to butanol-started polyoxypropylene monools having an average molecular weight Mₙ in the range from 650 to 2′000 g/mol, especially 700 to 1′500 g/mol. Butanol-started polyoxypropylene monools are commercially available, for example as Synalox® 100-20B, Synalox® 100-40B or Synalox® 100-85B (all from Dow).

Preference is further given to polyoxypropylene diols having an OH number in the range from 12 to 125 mg KOH/g, preferably in the range from 22 to 125 mg KOH/g, especially in the range from 45 to 125 mg KOH/g.

Preference is further given to trimethylolpropane—or especially glycerol-started polyoxypropylene triols having an OH number in the range from 22 to 56 mg KOH/g, optionally containing proportions of 1,2-ethyleneoxy groups.

The moisture-curing polyurethane composition preferably contains 7.5% to 40% by weight, especially 10% to 25% by weight, of polyethers having blocked hydroxyl groups. Such a composition has good processibility and high extensibility coupled with high strength and particularly good adhesion to automotive paints.

The moisture-curing polyurethane composition may additionally contain further polymers containing isocyanate groups, especially smaller proportions of polymers containing isocyanate groups based on polyester polyols or polybutadiene polyols with respect to the polyether urethane polymer.

The moisture-curing polyurethane composition preferably additionally comprises at least one further constituent selected from catalysts and fillers.

Suitable catalysts are catalysts for accelerating the reaction of isocyanate groups, in particular organotin(IV) compounds, such as, in particular, dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), in particular with ligands selected from alkoxides, carboxylates, 1,3-diketonates, oxinate, 1,3-ketoesterates, and 1,3-ketoamidates, or compounds containing tertiary amino groups, such as, in particular, 2,2′-dimorpholinodiethyl ether (DMDEE).

Suitable fillers are especially ground or precipitated calcium carbonates, optionally coated with fatty acids, especially stearates, barytes, quartz flours, quartz sands, dolomites, wollastonites, calcined kaolins, sheet silicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads.

Preference is given to calcium carbonates that have optionally been coated with fatty acids, especially stearates, calcined kaolins or industrially produced carbon blacks.

The composition of the invention preferably contains between 15% and 30% by weight of carbon black, based on the overall composition.

Suitable carbon blacks are all standard industrial carbon blacks that can be used in polyurethane compositions and are known to the person skilled in the art.

The use of carbon black in the stated amount brings the advantage that the composition increases in mechanical strength (especially with regard to tensile strength and modulus of elasticity), and also reduces the formation of bubbles in the course of curing. Within the specified range, moreover, application is still simple enough for the composition also to be applicable manually. The mass can thicken rapidly in the case of higher carbon black contents.

The moisture-curing polyurethane composition may contain further additions, in particular
inorganic or organic pigments, especially titanium dioxide, chromium oxides or iron oxides;
fibers, in particular glass fibers, carbon fibers, metal fibers, ceramic fibers, polymer fibers, such as polyamide fibers or polyethylene fibers, or natural fibers, such as wool, cellulose, hemp or sisal;
nanofillers such as graphene or carbon nanotubes;
dyes;
desiccants, in particular molecular sieve powders, calcium oxide, highly reactive isocyanates such as p-tosyl isocyanate, monooxazolidines such as Incozol® 2 (from Incorez) or orthoformic esters;
adhesion promoters, in particular organoalkoxysilanes, in particular epoxysilanes, such as in particular 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes, or titanates;
blocked amines, especially oxazolidines or aldimines, especially di- or trialdimines;
further plasticizers, especially carboxylic acid esters, such as phthalates, especially diisononyl phthalate (DINP), diisodecyl phthalate (DIDP) or di(2-propylheptyl)phthalate (DPHP), hydrogenated phthalates, especially hydrogenated diisononyl phthalate or diisononyl cyclohexane-1,2-dicarboxylate (DINCH), terephthalates, especially bis(2-ethylhexyl) terephthalate or diisononyl terephthalate, hydrogenated terephthalates, especially hydrogenated bis(2-ethylhexyl) terephthalate or diisononyl terephthalate, or bis(2-ethylhexyl) cyclohexane-1,4-dicarboxylate, trimellitates, adipates, especially dioctyl adipate, azelates, sebacates, benzoates, glycol ethers, glycol esters, organic phosphoric or sulfonic acid esters, polybutenes, polyisobutenes or plasticizers derived from natural fats or oils, especially epoxidized soybean or linseed oil;
further catalysts which accelerate the reaction of the isocyanate groups, especially salts, soaps or complexes of tin, zinc, bismuth, iron, aluminum, molybdenum, dioxomolybdenum, titanium, zirconium or potassium, especially tin(II) 2-ethylhexanoate, tin(II) neodecanoate, zinc(II) acetate, zinc(II) 2-ethylhexanoate, zinc(II) laurate, zinc(II) acetylacetonate, aluminum lactate, aluminum oleate, diisopropoxytitanium bis(ethyl acetoacetate) or potassium acetate; compounds containing tertiary amino groups, especially N-ethyldiisopropylam ine, N,N,N′,N′-tetramethylalkylenediamines, pentamethylalkylenetriamines and higher homologs thereof, bis(N,N-diethylaminoethyl) adipate, tris(3-dimethylaminopropyl)amine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-alkylmorpholines, N,N′-dimethylpiperazine; aromatic nitrogen compounds, such as 4-dimethylam inopyridine, N-methylimidazole, N-vinylimidazole or 1,2-dimethylimidazole; organic ammonium compounds, such as benzyltrimethylammonium hydroxide or alkoxylated tertiary amines; what are called “delayed action” catalysts, which are modifications of known metal or amine catalysts;
rheology modifiers, in particular thickeners, in particular sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
solvents, in particular acetone, methyl acetate, tert-butyl acetate, 1-methoxy-2-propyl acetate, ethyl 3-ethoxypropionate, diisopropyl ether, diethylene glycol diethyl ether, ethylene glycol diethyl ether, ethylene glycol monobutyl ether, ethylene glycol mono-2-ethylhexyl ether, acetals such as propylal, butylal, 2-ethylhexylal, dioxolane, glycerol formal or 2,5,7,10-tetraoxaundecane (TOU), toluene, xylene, heptane, octane, naphtha, white spirit, petroleum ether or gasoline, in particular Solvesso™ grades (from Exxon), and propylene carbonate, dimethyl carbonate, butyrolactone, N-methylpyrrolidone, N-ethylpyrrolidone, p-chlorobenzotrifluoride or benzotrifluoride;
natural resins, fats or oils, such as rosin, shellac, linseed oil, castor oil or soybean oil;
nonreactive polymers, especially homo- or copolymers of unsaturated monomers, especially from the group comprising ethylene, propylene, butylene, isobutylene, isoprene, vinyl acetate or alkyl (meth)acrylates, especially polyethylenes (PE), polypropylenes (PP), polyisobutylenes, ethylene/vinyl acetate copolymers (EVA) or atactic poly-α-olefins (APAO);
flame-retardant substances, especially the aluminum hydroxide or magnesium hydroxide fillers already mentioned, and also especially organic phosphoric esters, such as, in particular, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis—or tris(isopropylphenyl) phosphates of different degrees of isopropylation, resorcinol bis(diphenylphosphate), bisphenol A bis(diphenylphosphate) or ammonium polyphosphates;
additives, especially wetting agents, leveling agents, defoamers, deaerators, stabilizers against oxidation, heat, light or UV radiation, or biocides;

or further substances customarily used in moisture-curing polyurethane compositions.

It may be advisable to chemically or physically dry certain substances before mixing them into the composition.

The composition of the invention preferably additionally contains at least one further plasticizer, especially a phthalate, preferably in an amount of between 1% and 15% by weight, preferably between 1% and 10% by weight, based on the overall composition. The use of further plasticizers has the advantage that the formulation becomes cheaper, easier to formulate (to mix) and to apply, and has improved mechanical properties (especially elongation at break). It has been found that, surprisingly, the use of up to 15% by weight of further plasticizer does not impair adhesion to substrates that are difficult to bond.

Suitable further plasticizers are all standard plasticizers in the field of polyurethane formulation, especially those mentioned further up in the enumeration as further plasticizers. Preferred further plasticizers are especially carboxylic esters such as phthalates, especially diisononyl phthalate (DINP), diisodecyl phthalate (DIDP) or di(2-propylheptyl) phthalate (DPHP), hydrogenated phthalates, especially hydrogenated diisononyl phthalate or diisononyl cyclohexane-1,2-dicarboxylate (DINCH), terephthalates, especially bis(2-ethylhexyl) terephthalate or diisononyl terephthalate, and adipates, especially dioctyl adipate.

In the production of the polyurethane composition of the invention, the monomeric diisocyanate content is optionally further reduced by reaction with moisture present on mixing of the polyurethane polymer containing isocyanate groups with further constituents of the composition, especially fillers, which can be advantageous.

The moisture-curing polyurethane composition preferably contains
35% to 60% by weight of polyether urethane polymer containing isocyanate groups;—
6% to 25% by weight of polyether having blocked hydroxyl groups;
0% to 15% by weight of further plasticizers, especially phthalates;
1% to 3.5% by weight of isocyanurate-containing trimer I;
20% to 60% by weight of fillers, especially comprising carbon black; and optionally further constituents, especially catalysts, stabilizers, thixotropic agents and blocked amines.

The moisture-curing polyurethane composition is in particular produced with exclusion of moisture and stored at ambient temperature in moisture-tight containers. A suitable moisture-tight container especially consists of an optionally coated metal and/or plastic, and is especially a drum, a transport box, a hobbock, a bucket, a canister, a can, a bag, a tubular bag, a cartridge or a tube.

The moisture-curing polyurethane composition is a one-component composition. A composition referred to as a “one-component” composition is one in which all constituents of the composition are in the same container and which is storage-stable as is.

Given suitable packaging and storage, it is storage-stable, typically for several months up to one year or longer.

On application of the moisture-curing polyurethane composition, the curing process commences. This results in formation of the cured composition.

The one-component composition of the invention is applied as is and then begins to cure under the influence of moisture or water. For acceleration of curing, an accelerator component that contains or releases water and/or a catalyst and/or a curing agent can be mixed into the composition on application, or the composition, after application thereof, can be contacted with such an accelerator component.

In the course of curing, the isocyanate groups react with one another under the influence of moisture. If the moisture-curing polyurethane composition contains a blocked amine, the isocyanate groups additionally react with the blocked amino groups as they are hydrolyzed. The totality of these reactions of isocyanate groups that lead to the curing of the composition is also referred to as crosslinking.

The moisture needed for curing the moisture-curing polyurethane composition preferably gets into the composition through diffusion from the air (atmospheric moisture). In the process, a solid layer of cured composition (“skin”) is formed on the surfaces of the composition which come into contact with air. Curing proceeds in the direction of diffusion from the outside inward, the skin becoming increasingly thick and ultimately covering the entire composition that was applied. The moisture can also get into the composition additionally or entirely from one or more substrate(s) to which the composition has been applied and/or can come from an accelerator component that is mixed into the composition on application or is contacted therewith after application, for example by painting or spraying.

The moisture-curing polyurethane composition is preferably applied at ambient temperature, in particular within a range from about −10 to 50° C., preferably within a range from −5 to 45° C., in particular 0 to 40° C.

The moisture-curing polyurethane composition is preferably likewise cured at ambient temperature.

The moisture-curing polyurethane composition has a long processing time (open time) and rapid curing.

“Open time” refers to the period of time during which the composition can be processed or reprocessed after application without any loss of its ability to function. If the composition is used as adhesive, the open time especially also refers to the period of time within which a bond must have been made after application thereof in order to develop sufficient adhesion. In the case of a one-component composition, the open time has been exceeded when a skin has formed, if not sooner.

The “curing rate” refers to the degree of polymer formation in the composition within a given period of time after application, for example by determining the thickness of the skin formed.

The moisture-curing polyurethane composition after curing preferably has a tensile strength of at least 7 MPa, preferably at least 8 MPa, especially at least 9 MPa, determined to DIN EN 53504 at a tension rate of 200 mm/min, especially as described in the examples.

The moisture-curing composition after curing preferably also has an elongation at break of at least 300%, especially at least 400%, determined to DIN EN 53504 at a tension rate of 200 mm/min, especially as described in the examples.

The moisture-curing polyurethane composition after curing preferably also has a modulus of elasticity of at least 7 MPa, especially at least 8 MPa, determined at 0.5-5% elongation to DIN EN 53504 at a tension rate of 200 mm/min, especially as described in the examples.

Preference is given to using the moisture-curing polyurethane composition as elastic adhesive or elastic sealant or elastic coating.

The moisture-curing polyurethane composition as adhesive and/or sealant is especially suitable for bonding and sealing applications in the construction and manufacturing industry or in motor vehicle construction, especially for parquet bonding, assembly, bonding of installable components, module bonding, pane bonding, join sealing, bodywork sealing, seam sealing or cavity sealing. Elastic bonds in vehicle construction are, for example, the bonded attachment of parts such as plastic covers, trim strips, flanges, fenders, driver's cabins or other installable components to the painted body of a vehicle, or the bonding of panes into the vehicle body, said vehicles especially being automobiles, trucks, buses, rail vehicles or ships.

The moisture-curing polyurethane composition is especially suitable as sealant for the elastic sealing of all kinds of joins, seams or cavities, especially of joins in construction, such as expansion joins or connection joins between structural components, or of floor joins in civil engineering. A sealant having flexible properties and high cold flexibility is particularly suitable especially for the sealing of expansion joins in built structures.

As a coating, the moisture-curing polyurethane composition is especially suitable for protection and/or for sealing of built structures or parts thereof, especially for balconies, terraces, roofs, especially flat roofs or slightly inclined roof areas or roof gardens, or in building interiors beneath tiles or ceramic plates in wet rooms or kitchens, or in collection pans, conduits, shafts, silos, tanks or wastewater treatment systems.

It can also be used for repair purposes as seal or coating, for example of leaking roof membranes or floor coverings that are no longer fit for purpose, or as repair compound for highly reactive spray seals.

The moisture-curing polyurethane composition can be formulated such that it has a pasty consistency with structurally viscous properties. A composition of this kind is applied by means of a suitable device, for example from commercial cartridges or drums or hobbocks, for example in the form of a bead, which may have an essentially round or triangular cross-sectional area.

The moisture-curing polyurethane composition can also be formulated such that it is fluid and “self-leveling” or only slightly thixotropic and can be poured out for application. As coating, it can, for example, subsequently be distributed over an area up to the desired layer thickness, for example by means of a roller, a slide bar, a toothed applicator or a trowel. In one operation, typically a layer thickness in the range from 0.5 to 3 mm, especially 1.0 to 2.5 mm, is applied.

Suitable substrates which can be bonded or sealed or coated with the moisture-curing polyurethane composition are especially
glass, glass ceramic, concrete, mortar, cement screed, fiber cement, especially fiber cement boards, brick, tile, gypsum, especially gypsum boards or anhydride screed, or natural stone, such as granite or marble;
repair or leveling compounds based on PCC (polymer-modified cement mortar) or ECC (epoxy resin-modified cement mortar); metals or alloys, such as aluminum, copper, iron, steel, nonferrous metals, including surface-finished metals or alloys, such as zinc-plated or chromium-plated metals;
asphalt or bitumen;
leather, textiles, paper, wood, woodbase materials bonded with resins such as phenolic, melamine or epoxy resins, resin-textile composites or other so-called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
paints or coatings, especially automotive topcoats, and especially also hydrophobic automotive paints of high scratch resistance.

If required, the substrates can be pretreated prior to application, especially by physical and/or chemical cleaning methods or the application of an activator or a primer. However, this is not preferred, and the composition of the invention adheres even without such pretreatment steps.

It is possible to bond and/or seal two identical or two different substrates.

The invention further provides a method of bonding or sealing, comprising the steps of
(i) applying the moisture-curing polyurethane composition
   to a first substrate and contacting the composition with a second substrate within the open time of the composition, or
   to a first and to a second substrate and joining the two substrates within the open time of the composition, or
   between two substrates,
(ii)curing the composition by contact with moisture.

In preferred embodiments of this process, one of the substrates is a surface that has been painted with automotive paint and/or no pretreatment has been conducted on this substrate apart from optional cleaning prior to the application of the polyurethane composition.

The invention further provides a method of coating or sealing, comprising the steps of
(i) applying the moisture-curing polyurethane composition to a substrate,
(ii)curing the composition by contact with moisture.

The application and curing of the moisture-curing polyurethane composition or the method of bonding or sealing or the method of coating or sealing affords an article bonded or sealed or coated with the composition. This article may be a built structure or a part thereof, especially a built structure in civil engineering above or below ground, a bridge, a roof, a staircase or a façade, or it may be an industrial good or a consumer good, especially a window, a pipe, a rotor blade of a wind turbine, a domestic appliance or a mode of transport, such as especially an automobile, a bus, a truck, a rail vehicle, a ship, an aircraft or a helicopter, or an installable component thereof.

The invention thus further provides an article obtained from the described method of bonding or sealing or from the described method of coating or sealing.

The one-component moisture-curing polyurethane composition has advantageous properties.

It has excellent adhesion properties, especially also on paint substrates that are difficult to bond, such as hydrophobic automotive paint having high scratch resistance.

It also has very good heat stability in the cured state and does not lose adhesion even in the course of prolonged exposure to heat.

In preferred embodiments, on account of the low monomeric diisocyanate content, it can be handled safely even without special safety precautions and does not require any hazard labeling in relation to the monomeric diisocyanates. In addition, the composition is very storage-stable with exclusion of moisture, has very good applicability and has a long processing time (open time) coupled with surprisingly rapid curing. This gives rise to an elastic material of surprisingly high tensile strength coupled with high extensibility, with high cold flexibility, good bonding properties and high stability to heat and moisture.

### EXAMPLES

Working examples are adduced hereinafter, which are intended to further elucidate the invention described. The invention is of course not limited to these described working examples.

“Standard climatic conditions” (“SCC”) refer to a temperature of 23±1° C. and a relative air humidity of 50±5%.

Unless stated otherwise, the chemicals used were from Sigma-Aldrich.

### Preparation of Polyethers Having Blocked Hydroxyl Groups

Viscosity was measured using a thermostated Rheotec RC30 cone-plate viscometer (cone diameter 25 mm, cone angle 1°, cone tip-plate distance 0.05 mm, shear rate 10 s⁻¹).

Infrared spectra (FT-IR) were measured as undiluted films on a Nicolet iS5 FT-IR instrument from Thermo Scientific equipped with a horizontal ATR measurement unit with a diamond crystal. Absorption bands are reported in wavenumbers (cm⁻¹).

¹H NMR spectra were measured on a spectrometer of the Bruker Ascend 400 type at 400.14 MHz; the chemical shifts 6 are reported in ppm relative to tetramethylsilane (TMS). No distinction was made between true coupling and pseudo-coupling patterns.

Polymeric Plasticizer PL1:

Butanol-started acetylated PPG monool with average molecular weight Mₙ about 790 g/mol

120.00 g of butanol-started polyoxypropylene monool (Synalox® 100-20B, average molecular weight Mₙ about 750 g/mol; from Dow) and 18.74 g of acetic acid anhydride were initially charged in a round-bottom flask with distillation attachment under a nitrogen atmosphere. Then the reaction mixture was stirred under a gentle nitrogen stream at 130° C., with collection of acetic acid as distillate. Subsequently, the volatile constituents were removed from the reaction mixture at 80° C. and a reduced pressure of 10 mbar. A clear, colorless liquid having a viscosity of 74 mPa·s at 20° C. was obtained. FT-IR: 2970, 2931, 2867, 1738, 1454, 1372, 1345, 1296, 1241, 1098, 1014, 959, 925, 866, 827.

¹H NMR (CDCl₃): 5.02 (hept., 1 H, CH₂(CH₃)CH—OAc), 3.75-3.34 (2×m, ca. 39 H, OCH₂CH(CH₃)O), 3.33-3.28 (m, 2H, CH₃CH₂CH₂CH₂O), 2.04 (s, 3H, O(CO)CH₃), 1.55 (quint., 2 H, CH₃CH₂CH₂CH₂O), 1.36 (sext., 2 H, CH₃CH₂CH₂CH₂O), 1.22 (d, 3H, CH₂(CH₃)CH—OAc), 1.17-1.10 (m, ca. 36 H, OCH₂CH(CH₃)O), 0.91 (t, 3H, CH₃CH₂CH₂CH₂O).

### Preparation of Polymers Containing Isocyanate Groups

Viscosity was measured using a thermostated (20° C., unless stated otherwise) Rheotec RC30 cone-plate viscometer (cone diameter 50 mm, cone angle 1°, cone tip-plate distance 0.05 mm, shear rate 10 s⁻¹) (or, if so stated, 50 s⁻¹).

Monomeric diisocyanate content was determined by means of HPLC (detection via photodiode array; 0.04 M sodium acetate/acetonitrile as mobile phase) after prior derivation by means of N-propyl-4-nitrobenzylamine.

Polymer P1:

6950 g of polyoxypropylenepolyoxyethylene triol (Caradol® MD34-02, Shell Chemicals Ltd., UK; OH number 35.0 mg KOH/g), 1145 g of 4,4′-methylene diphenyl diisocyanate (4,4′-MDI; Desmodur® 44 MC L, Bayer MaterialScience AG), and 203 g of diisodecyl phthalate (DIDP; Palatinol® Z, BASF SE, Germany) were reacted at 80° C. by a known method to give an NCO-terminated polyurethane polymer having an isocyanate group content of 2.38% by weight. Viscosity was 50-60 Pa·s at 20° C. and 50 s⁻¹.

Polymer P2:

400 g of polyoxypropylene diol (Acclaim® 4200, from Covestro AG; OH value 28.5 mg KOH/g) and 52 g of diphenylmethane 4,4′-diisocyanate (Desmodur® 44 MC L, from Covestro AG) were reacted by a known procedure at 80° C. to give an NCO-terminated polyurethane polymer that is liquid at room temperature and has an isocyanate group content of 1.85% by weight. Viscosity was 30-40 Pa·s at 20° C. and 50 s⁻¹.

Polymer P3:

682.9 g of Voranol® CP 4755 polyether triol and 317.0 g of diphenylmethane 4,4′-diisocyanate (Desmodur® 44 MC L, from Covestro) were reacted by a known method at 80° C. to give a polyetherurethane polymer having an NCO content of 8.8% by weight, a viscosity of 5.1 Pas at 20° C. and a monomeric diphenylmethane 4,4′-diisocyanate content of about 25% by weight. Subsequently, the volatile constituents, especially a majority of the monomeric diphenylmethane 4,4′-diisocyanate, were removed by distillation in a short-path evaporator (jacket temperature 180° C., pressure 0.1 to 0.005 mbar, condensation temperature 47° C.). The polyetherurethane polymer thus obtained had an NCO content of 2.0% by weight, a viscosity of 16.8 Pas at 20° C., a monomeric diphenylmethane 4,4′-diisocyanate content of 0.05% by weight and an average molecular weight of about 5700 g/mol.

Polymer P4:

727.0 g of Acclaim® 4200 (polyoxypropylene diol, OH number 28.0 mg KOH/g; from Covestro) and 273.0 g of diphenylmethane 4,4′-diisocyanate (Desmodur® 44 MC L, from Covestro) were converted by a known method at 80° C. to a polyetherurethane polymer having an NCO content of 7.6% by weight, a viscosity of 5.2 Pas at 20° C. and a monomeric diphenylmethane 4,4′-diisocyanate content of about 18% by weight.

Subsequently, the volatile constituents, especially a majority of the monomeric diphenylmethane 4,4′-diisocyanate, were removed by distillation in a short-path evaporator (jacket temperature 180° C., pressure 0.1 to 0.005 mbar, condensation temperature 47° C.). The polyether urethane polymer thus obtained had an NCO content of 1.8% by weight, a viscosity of 15.2 Pas at 20° C. and a monomeric diphenylmethane 4,4′-diisocyanate content of 0.08% by weight.

Moisture-Curing Polyurethane Compositions:

Compositions Z1 to Z14:

For each composition, the ingredients specified in tables 1 to 3 were mixed in the amounts specified (in parts by weight) by means of a centrifugal mixer (SpeedMixer™ DAC 150, FlackTek Inc.) with exclusion of moisture at 3000 rpm for one minute and stored with exclusion of moisture. Each composition was tested as follows:

As a measure of mechanical properties and stability to heat and hydrolysis, each composition was pressed between two wax-coated transfer printing papers to give a film of thickness 2 mm and stored under standard climatic conditions for 7 days. After the wax papers had been removed, a few dumbbells having a length of 75 mm and the bar length of 30 mm and a bar width of 4 mm were punched out of the film. These were used to determine tensile strength, elongation at break and E modulus at 0.5-5% or elongation in accordance with DIN EN 53504 at a strain rate of 200 mm/min. These results are given the addition “7 d SCC”. In addition, further punched-out dumbbells were stored in an air circulation oven at 90° C. for 7 days, cooled down under standard climatic conditions and tested in the manner already described for tensile strength, elongation at break, and modulus of elasticity. These results are given the addition “7 d 90° C.”.

G modulus (shear modulus) was determined by measuring the samples at 23° C. and 50% relative air humidity to DIN 54 451 after storage at room temperature and 50% relative air humidity for 7 days. The aluminum substrates used for this purpose were pretreated prior to bonding with Sika® Primer 204N, available from Sika Schweiz AG.

The results from the abovementioned test methods are reported in table 4.

Adhesion was determined by cleaning various automotive paint substrates by means of a heptane-soaked cellulose cloth (Tele, Tela-Kimberly Switzerland GmbH). Within 10 minutes, a triangular bead (height 12 mm, width 8 mm) of the composition to be tested was then applied by means of an extrusion cartridge and nozzle and pressed together with a polypropylene film to a thickness of 4-5 mm.

The adhesive was tested after a curing time of 7 days (‘7d RT’) or 14 days (‘14d RT’) under standard climatic conditions (23° C., 50% rel. humidity), and after subsequent storage at 40° C. (‘7d 40° C., 100% r.h.’) and 100% rel. humidity for 7 days, and with the same storage after 14 days (‘14d 40° C., 100% r.h.’) and 21 days (‘21d 40° C., 100% r.h.’).

The adhesion of the adhesive was tested in each case using the ‘bead test’. This involves cutting into the cured adhesive layer at its end just above the adhesive bonding surface. The cut end of the layer is held with round-nose pliers and pulled away from the substrate. This is done by carefully rolling up the adhesive layer onto the tip of the pliers, and making a cut at right angles to the pulling direction down to the bare substrate. The pulling speed should be chosen such that a cut has to be made about every 3 seconds. The test distance must correspond to at least 8 cm. What is assessed is the adhesive remaining on the substrate after the adhesive layer has been pulled away (cohesion fracture). The adhesion properties are assessed by visual determination of the cohesive proportion of the bonding area.

The higher the proportion of cohesive failure the better the adhesive bonding. Test results with proportions of cohesive failure of less than 60%, in particular less than 50%, are typically considered inadequate.

The substrates used were steel sheets painted with automotive paints. The adhesives were applied directly to the paint surface. The paint substrates used were:
iGloss® HAPS (BASF, Germany)
iGloss® (BASF, Germany)
Axalta® Lumeera (Axalta Coating Systems, USA)

All substrates were cleaned immediately prior to the application of the adhesion promoter composition by wiping by means of a cellulose cloth (Tela®, Tela-Kimberly Switzerland GmbH) that had been soaked with heptane, and vented for at least 5 minutes prior to the application of the adhesion promoter composition and subsequently wiped dry with a cellulose cloth (“wipe on/wipe off”). The results are reported in Tables 5 and 6.

Compositions Z2, Z3, Z5 and Z6 are inventive examples. Compositions Z1, Z4 and Z7 to Z14 are comparative examples and are given the addition “(Ref.)”. Comparative examples Z1 and Z7 to Z10 and Z12 to Z14 do not contain any polyether with blocked hydroxyl groups (plasticizer PL1), and comparative example Z4 contains too little isocyanurate I.Z11 contains too little plasticizer PL1.

TABLE 1
Composition (in parts by weight) of Z1 to Z3

| Composition | Z1 (ref.) | Z2 | Z3 |
|---|---|---|---|
| Polymer P1 | 14 | 14 | 14 |
| Polymer P2 | 31 | 31 | 31 |
| DIDP | 15 | 5 | — |
| Plasticizer PL1 | — | 10 | 15 |
| Isocyanurate I1 | 2 | 2 | 2 |
| Desiccant ⁴ | 0.1 | 0.1 | 0.1 |
| Carbon black ¹ | 20 | 20 | 20 |
| Kaolin ² | 17 | 17 | 17 |
| Catalyst ³ | 0.8 | 0.8 | 0.8 |

¹ Monarch 570 (from Cabot)
² White Tex (from BASF)
³ 2,2′-dimorpholinodiethyl ether and dibutyltin dilaurate (10:1 weight ratio as a mixture to 10% by weight in DIDP)
⁴ p-toluenesulfonyl isocyanate

TABLE 2
Composition (in parts by weight) of Z4 to Z9

| | Z4 | | | Z7 | Z8 | Z9 |
|---|---|---|---|---|---|---|
| Composition | (ref.) | Z5 | Z6 | (ref.) | (ref.) | (ref.) |
| Polymer P3 | 14 | 14 | 14 | 14 | 16 | 18 |
| Polymer P4 | 31 | 31 | 31 | 31 | 34 | 37 |
| DIDP | — | — | — | 15 | 10 | 5 |
| Plasticizer PL1 | 15 | 15 | 15 | — | — | — |
| Isocyanurate I1 | 0.9 | 3.5 | 2 | 2 | 2 | 2 |
| Desiccant ⁴ | 0.1 | 0.1 | 0.1 | 0.1 | 0.1 | 0.1 |
| Carbon black ¹ | 20 | 20 | 20 | 20 | 20 | 20 |
| Kaolin ² | 17 | 17 | 17 | 17 | 17 | 17 |
| Catalyst ³ | 0.8 | 0.8 | 0.8 | 0.8 | 0.8 | 0.8 |

¹ Monarch 570 (from Cabot)
² White Tex (from BASF)
³ 2,2′-dimorpholinodiethyl ether and dibutyltin dilaurate (10:1 weight ratio as a mixture to 10% by weight in DIDP)
⁴ p-toluenesulfonyl isocyanate

TABLE 3
Composition (in parts by weight) of Z10 to Z14

| | Z10 | Z11 | Z12 | Z13 | Z14 |
|---|---|---|---|---|---|
| Composition | (ref.) | (ref.) | (ref.) | (ref.) | (ref.) |
| Polymer P3 | 20 | 15 | 14 | 14 | 14 |
| Polymer P4 | 40 | 40 | 31 | 41 | 36 |
| DIDP | — | — | 15 | — | — |
| Plasticizer PL1 | — | 5 | — | — | — |
| Diol 12200 | — | — | — | 5 | 10 |
| Isocyanurate I1 | 2 | 2 | 2 | 2 | 2 |
| Desiccant ⁴ | 0.1 | 0.1 | 0.1 | 0.1 | 0.1 |
| Carbon black ¹ | 20 | 20 | 20 | 20 | 20 |
| Kaolin ² | 17 | 17 | 17 | 17 | 17 |
| Catalyst ³ | 0.8 | 0.8 | 0.8 | 0.8 | 0.8 |

¹ Monarch 570 (from Cabot)
² White Tex (from BASF)
³ 2,2′-dimorpholinodiethyl ether and dibutyltin dilaurate (10:1 weight ratio as a mixture to 10% by weight in DIDP)
⁴ p-toluenesulfonyl isocyanate

TABLE 4
Measurement results with mechanical data.

| | Z4 | | | Z7 | | Z3 |
|---|---|---|---|---|---|---|
| Composition | (ref.) | Z5 | Z6 | (ref.) | Z1 | (ref.) |
| Tensile strength 7 d SCC | 10.3 | 10.2 | 11 | 11.2 | 10.1 | 10 |
| [MPa] | | | | | | |
| Tensile strength 7 d 90° C. | 10.9 | 10.3 | 10.9 | 10.4 | 9 | 8.8 |
| [MPa] | | | | | | |
| E modulus 7 d SCC [MPa] | 6.7 | 9.4 | 7.4 | 7.8 | 8.2 | 8.3 |
| E modulus 7 d 90° C. [MPa] | 6 | 8.6 | 6.7 | 7.1 | 7.4 | 7.5 |
| Elongation at break 7 d SCC | 494 | 308 | 454 | 476 | 447 | 454 |
| [%] | | | | | | |
| Elongation at break 7 d 90° C. | 528 | 329 | 458 | 435 | 408 | 412 |
| [%] | | | | | | |
| G modulus 7 d SCC [MPa] | 2.2 | 3.1 | 2.4 | 2.5 | 3 | 3.1 |

It is to be seen from table 4 that the inventive compositions Z1, Z5 and Z6 have excellent mechanical values that persist even after heated storage, which suggests excellent heat stability. Comparative experiments with conventional plasticizers are at most equivalent in mechanical terms. Comparative experiment Z4 has values for E modulus and G modulus that are too low.

TABLE 5
Results of the adhesion test (values in % cohesive fracture).
“n/m” means that the value was not measured.

| | | 7 d | 14 d | 21 d |
|---|---|---|---|---|
| | 7 d | 40° C. ^{1, 2} | 40° C. ^{1, 2} | 40° C. ^{1, 2} |
| Composition | RT ^{1, 2} | 100% r.h. | 100% r.h. | 100% r.h. |
| Z4 (ref.) | 30 | 0 | 0 | 0 |
| Z5 | 100 | 100 | 100 | 100 |
| Z6 | 100 | 100 | 100 | n/m |
| Z7 (ref.) | 25 | 0 | 0 | 0 |
| Z8 (ref.) | 25 | 0 | 0 | n/m |
| Z9 (ref.) | 0 | 0 | 0 | n/m |
| Z10 (ref.) | 0 | 0 | 0 | n/m |
| Z11 (ref.) | 0 | 0 | 0 | n/m |
| Z12 (ref.) | 20 | 15 | 5 | n/m |
| Z13 (ref.) | 5 | 0 | 0 | n/m |
| Z14 (ref.) | 15 | 0 | 0 | n/m |

¹ Substrate (paint): iGloss ® HAPS (BASF)
Pretreatment: heptane (wipe on/wipe off)
² Open time: 5 min

TABLE 6
Results of the adhesion test (values in % cohesive fracture).

| | | | | 7 d | 14 d | 21 d |
|---|---|---|---|---|---|---|
| | | | | 40° C. | 40° C. | 40° C. |
| | Substrate | 7 d | 14 d | 100% | 100% | 100% |
| Composition | (paint)^{1, 2} | RT | RT | r.h. | r.h. | r.h. |
| Z1 (ref.) | Axalta ® | 75 | 20 | 20 | 90 | 70 |
| Z2 | Lumeera | 100 | 100 | 80 | 100 | 95 |
| Z3 | overbaked | 90 | 100 | 100 | 100 | 100 |
| | (Axalta) | | | | | |
| Z1 (ref.) | iGloss ® | 85 | 60 | 70 | 70 | 70 |
| Z2 | overbaked | 100 | 95 | 70 | 85 | 85 |
| Z3 | (BASF) | 100 | 100 | 95 | 95 | 95 |
| Z1 (ref.) | iGloss ® | 100 | 100 | 80 | 75 | 65 |
| Z2 | HAPS | 100 | 100 | 100 | 100 | 100 |
| Z3 | overbaked | 100 | 100 | 100 | 100 | 100 |
| | (BASF) | | | | | |

¹ Pretreatment: heptane (wipe on/wipe off)
² Open time: 2 min

The data in tables 5 and 6 show that only the compositions of the invention have sufficient adhesion to the automotive paints of high scratch resistance that are difficult to bond. At the same time, they do not lose adhesion even after hot storage.

1. A moisture-curing one-component polyurethane composition comprising
at least one polyether urethane polymer containing isocyanate groups that has been obtained from the reaction of at least one polyisocyanate with at least one polyether polyol;
at least one isocyanurate-containing trimer I of 1-isocyanato-3,3,5-trimethyl-5-isocyanatomethylcyclohexane or hexane 1,6-diisocyanate in an amount present in the composition of between 1% and 4% by weight;
at least one polyether having blocked hydroxyl groups which is free of isocyanate groups as plasticizer, in an amount present in the composition of more than 5% by weight.

2. The polyurethane composition as claimed in claim 1, wherein the polyether urethane polymer has an NCO content in the range from 0.5% to 6.0% by weight.

3. The polyurethane composition as claimed in claim 1, wherein the at least one polyether urethane polymer containing isocyanate groups has a monomeric diisocyanate content of not more than 0.5% by weight and has been prepared from the reaction of at least one monomeric diisocyanate with at least one polyether polyol in an NCO/OH ratio of at least 3/1 and subsequent removal of a majority of the monomeric diisocyanates by means of a suitable separation process, and the polyurethane composition has a monomeric diisocyanate content of not more than 0.1% by weight.

4. The polyurethane composition as claimed in claim 1, wherein the polyisocyanate used for the reaction is a monomeric diisocyanate selected from diphenylmethane 4,4′-diisocyanate, tolylene 2,4-diisocyanate or mixtures thereof with tolylene 2,6-diisocyanate, 1-isocyanato-3,3,5-trimethyl-5-isocyanatomethylcyclohexane or hexane 1,6-diisocyanate.

5. The polyurethane composition as claimed in claim 1, wherein not more than 3.5% by weight of isocyanurate-containing trimer I is present in the composition.

6. The polyurethane composition as claimed in claim 1, wherein the blocked hydroxyl groups are selected from ester, aceto ester, carbonate, acetal and urethane groups.

7. The polyurethane composition as claimed in claim 1, wherein the composition contains between 15% and 30% by weight of carbon black, based on the overall composition.

8. The polyurethane composition as claimed in claim 1, wherein the polyether having blocked hydroxyl groups is derived from a hydroxy-functional polyether having an average OH functionality in the range from 1 to 3.

9. The polyurethane composition as claimed in claim 1, wherein the polyether having blocked hydroxyl groups has an average molecular weight Mₙ in the range from 600 to 15 000 g/mol, determined by means of gel permeation chromatography (GPC) versus polystyrene as standard with tetrahydrofuran as mobile phase, refractive index detector and evaluation from 200 g/mol.

10. The polyurethane composition as claimed in claim 1, wherein it contains 6% to 25% by weight of polyether having blocked hydroxyl groups.

11. The polyurethane composition as claimed in claim 1, wherein it additionally contains at least one further plasticizer.

12. The polyurethane composition as claimed in claim 1, wherein it contains
35% to 60% by weight of polyether urethane polymer containing isocyanate groups;
6% to 25% by weight of polyether having blocked hydroxyl groups;
0% to 15% by weight of further plasticizers;
1% to 3.5% by weight of isocyanurate-containing trimer I;
20% to 60% by weight of fillers; and optionally further constituents.

13. A method of bonding or sealing, comprising the steps of
(i) applying the polyurethane composition as claimed in claim 1
to a first substrate and contacting the composition with a second substrate within the open time of the composition, or
to a first and to a second substrate and joining the two substrates within the open time of the composition, or
between two substrates,
(ii) curing the composition by contact with moisture.

14. The method as claimed in claim 13, wherein one of the substrates is a surface that has been painted with automotive paint and no pretreatment has been conducted on this substrate apart from optional cleaning prior to the application of the polyurethane composition.

15. An article obtained from the method as claimed in claim 13.
